(19) United States
(12) Patent Application Publication
(10) Pub. No.: US 2024/0246706 A1
(43) Pub. Date: Jul. 25, 2024

(54) FILLING MECHANISM FOR USE IN HAZELNUT PROCESSING FACILITIES

(71) Applicant: BALSU GIDA SANAYI VE TICARET ANONIM SIRKETI, Sakarya (TR)

(72) Inventor: Nusret OZBAG, Sakarya (TR)

(73) Assignee: BALSU GIDA SANAYI VE TICARET ANONIM SIRKETI, Sakarya (TR)

(21) Appl. No.: 18/290,456

(22) PCT Filed: Mar. 9, 2022
(86) PCT No.: PCT/TR2022/050208

§ 371 Date: Nov. 14, 2023

(30) Foreign Application Priority Data
Jul. 5, 2021 (TR) 2021/010954

(51) Int. Cl. B65B 25/02; B03C 1/02; B65B 1/22; B65B 1/32; B65B 5/06; B65B 31/04

(52) U.S. Cl. CPC B65B 25/02; B03C 1/02; B65B 1/22; B65B 1/32; B65B 5/067; B65B 31/044; B03C 2201/20

(57) ABSTRACT

At least one filling mechanism for use in packaging of hazelnut processed in hazelnut processing facilities. The improvement of the present invention is that the subject matter filling mechanism comprises at least one first filling unit which can provide filling of hazelnut into at least one big bag, at least one second filling unit which can provide vacuuming and putting of hazelnut into packages which are dimensioned in a smaller manner when compared with the big bag, and at least one guide which can be associated with a hazelnut source in order to enable selectively feeding of hazelnut into at least one of the first filling unit and the second filling unit.

### CROSS REFERENCE TO RELATED APPLICATIONS

This application is the national phase entry of International Application No. PCT/TR2022/050208, filed on Mar. 9, 2022, which is based upon and claims priority to Turkey Patent Application No. 2021/010954, filed on Jul. 5, 2021, the entire contents of which are incorporated herein by reference.

### TECHNICAL FIELD

The present invention relates to at least one filling mechanism for use in packaging of hazelnut processed in hazelnut processing facilities.

### BACKGROUND

Hazelnut processing facilities include process steps until turning unshelled hazelnut into decorticated hazelnut. These process steps can include breaking, cleaning and packaging of hazelnut. Hazelnut is presented to market after being subjected to breaking and cleaning processes in hazelnut processing facilities.

In the process steps of hazelnut as from the inlet to the outlet in hazelnut processing facility, hazelnut passes through process steps like pre-sieving, breaking, packaging. After these process steps, hazelnut is brought into decorticated hazelnut form and hazelnut becomes ready for use. While hazelnut can be packaged in this step such that the end consumer will directly consume, at the same time, filling can be realized also in big packages for the companies which use hazelnut. This can be determined depending on order density. When hazelnut is packaged for the end consumer, it is desired to be filled in small volume receptacles, and when the hazelnut is packaged for companies, it is desired to be filled in large big bags. Packaging of hazelnut in different dimensions in this manner leads to a problem for organizations. Pluralities of organizations can give service in accordance with only one of these two filling types or may realize inefficient packaging.

The application with no WO2014078403A2 known in the literature relates to a storage and packaging facility. The invention provides storage, processing and packaging for cereals or grained structures. With the help of conveyors and elevators which exist in the system, grained structures are carried and are weighed and are filled into big bags. Grained structures which enter the system are processed and are separated from foreign substances. Calibration of grained structures is realized with the help of sieves provided in the system and packaging is provided.

Even though solutions which enable different type of filling in different areas have been developed in the literature, a similar solution for hazelnut has not been found. Thus, this leads to advance of the processing procedures in a primitive manner and formation of additional cost during processing of hazelnut.

As a result, because of the abovementioned problems, an improvement is required in the related technical field.

### SUMMARY

The present invention relates to a filling mechanism, for eliminating the abovementioned disadvantages and for bringing new advantages to the related technical field.

An object of the present invention is to provide a filling mechanism for use in hazelnut processing facilities.

Another object of the present invention is to provide a filling mechanism which can provide big bagging of the hazelnut.

Another object of the present invention is to provide a filling mechanism which can package hazelnut in a vacuumed manner.

In order to realize the abovementioned objects and the objects which are to be deducted from the detailed description below, the present invention is at least one filling mechanism for use in packaging of hazelnut processed in hazelnut processing facilities. Accordingly, the improvement is that the subject matter filling mechanism comprises at least one first filling unit which can provide filling of hazelnut into at least one big bag, at least one second filling unit which can provide vacuuming and putting of hazelnut into packages which are dimensioned in a smaller manner when compared with the big bag, and at least one guide which can be associated with a hazelnut source in order to enable selectively feeding of hazelnut into at least one of said first filling unit and said second filling unit. Thus, hazelnut can be filled into big bags or into vacuumed packages as desired.

In a possible embodiment of the present invention, at least one first magnetic detector and at least one second magnetic detector are respectively provided on said first filling unit and said second filling unit. Thus, the magnetic elements which exist in the hazelnut can be sorted.

In another possible embodiment of the present invention, there is at least one sampling unit on the first filling unit. Thus, the sample can be taken from the big bagged hazelnut.

In another possible embodiment of the present invention, on the first filling unit; at least one body is provided whereon the big bag can be positioned and at least one first load cell is provided between the body and the big bag. Thus, the weight of the hazelnut loaded to the big bag can be detected.

In another possible embodiment of the present invention, at least one first carrier is provided on the first filling unit. Thus, the big bag can be carried.

In another possible embodiment of the present invention, at least one pellet feeder is provided on the first filling unit. Thus, the pellet can be placed under the big bag.

In another possible embodiment of the present invention, at least one movement element is provided on the first filling unit. Thus, the filled big bag can be displaced.

In another possible embodiment of the present invention, at least one collecting band and at least one lift are provided for use in carrying the hazelnut on the second filling unit. Thus, the hazelnut displaces between operation steps.

In another possible embodiment of the present invention, at least one filling silo is provided on the second filling unit. Thus, hazelnut can be waited in a chamber.

In another possible embodiment of the present invention, at least one second load cell is provided on the second filling unit. Thus, the weight of the package wherein hazelnut is filled can be measured.

In another possible embodiment of the present invention, at least one dosing section is provided on the second filling unit. Thus, hazelnut is loaded into the package.

In another possible embodiment of the present invention, at least one vacuum element is provided on the second filling unit. Thus, the air which exists in the package is suctioned.

In another possible embodiment of the present invention, a vibration table is provided on the second filling unit. Thus, the package is vibrated and hazelnut is filled with minimum gaps in between.

In another possible embodiment of the present invention, at least one second carrier is provided on the second filling unit. Thus, the packaged hazelnut can be transported.

### BRIEF DESCRIPTION OF THE DRAWINGS

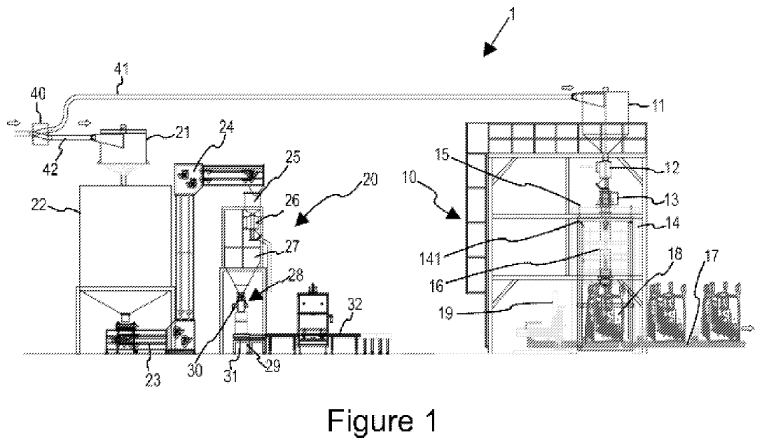

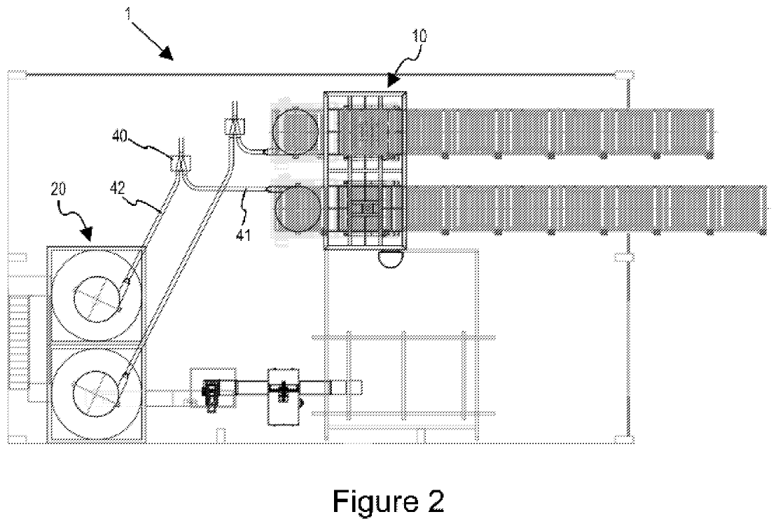

In FIG. 1, a representative lateral view of the subject matter filling mechanism is given. In FIG. 2, a representative top view of the subject matter filling mechanism is given.

### REFERENCE NUMBERS

1 Filling mechanism
10 First filling unit
11 First cyclone
12 First magnetic detector
13 Sampling unit
14 Body
141 Hanger
15 First load cell
16 Movement element
17 First carrier
18 Big bag
19 Pellet feeder
20 Second filling unit
21 Second cyclone
22 Vacuum silo
23 Collecting band
24 Lift
25 Buffer silo
26 Second magnetic detector
27 Filling silo
28 Dosing section
29 Vibration table
30 Vacuum element
31 Second load cell
32 Second carrier
40 Guide
41 First transmission pipe
42 Second transmission pipe.

### DETAILED DESCRIPTION OF THE EMBODIMENTS

In this detailed description, the subject matter is explained with references to examples without forming any restrictive effect only in order to make the subject more understandable.

In FIGS. 1 and 2, a representative one each views of the subject matter filling mechanism (1) is given. Accordingly, said filling mechanism (1) is particularly provided in the hazelnut processing plants and is configured to allow packaging of hazelnut for reaching of hazelnut to the consumer after passing of hazelnut through specific processes. The hazelnut processing facility described in the invention comprises the process steps as from unshelled hazelnut until decorticated hazelnut. The filling mechanism (1) provides collecting of decorticated hazelnut obtained after these processing steps, and packaging thereof in predetermined forms.

The filling mechanism (1) comprises at least one first filling unit (10) which can enable collecting of hazelnut in at least one big bag (18) and at least one second filling unit (20) which can enable packaging of hazelnut in relatively smaller dimensions with respect to big bag (18). There is at least one guide (40) for providing feeding of decorticated hazelnut to either one of said first filling unit (10) and said second filling unit (20) as needed. Said guide (40) is essentially associated with a hazelnut source and hazelnut can be transferred to these two parts as needed.

In the first filling unit (10), the hazelnut is loaded to at least one big bag (18). Said big bag (18) is essentially provided in a suitable dimension for mass purchases and enables carrying of hazelnut. Big bag is a carrying element, produced from laminated or non-laminated fabrics formed by weaving polypropylene yarns, for realizing packaging, carrying and storing of grained products.

In order to package hazelnut in the first filling unit (10), hazelnuts taken from the guide (40) are brought to at least one first cyclone (11) by means of a first transmission pipe (41). Said first cyclone (11) is a chamber configured to keep the hazelnut, taken from the first transmission pipe (41), at least for a while depending on the capacity of the first filling unit (10). There is at least one first magnetic detector (12) at the continuation of the first cyclone (11). Said first magnetic detector (12) enables separation of metal elements, if any, which has magnetization characteristic, from the product in the carried hazelnut. In the structure of the first magnetic detector (12), there can be magnetic-based separator elements and the elements, kept in this form, can be discharged outwardly by means of a discharge part. In a possible embodiment of the present invention, there can also be a silo (not shown in the figures) between the first magnetic detector (12) and the first cyclone (11). Thanks to said silo, while hazelnut is being fed to the first magnetic detector (12), it is enabled to be given in a dosed manner.

There is at least one sampling unit (13) at the continuation of the first magnetic detector (12) on the first filling unit (10). Said sampling unit (13) enables taking of sample hazelnut from the hazelnuts filled into the big bag (18). The hazelnut, from which a sample is taken, becomes ready for being big bagged. For providing this, at least one body (14) is provided on the first filling unit (10). Said body (14) is essentially formed in a manner enabling carrying of the big bag (18). In order to be able to realize this, there can be a hanger (141) on the body (14). Said hanger (141) can grab the big bag (18) through the holding parts thereof. There is at least one first load cell (15) on the body (14). Said first load cell (15) is a converter for converting a force into an electrical signal. By means of this, the weight of the hazelnut load loaded onto the big bag (18) can be detected.

There can be at least one movement element (16) on the first filling unit (10). Said movement element (16) at least partially actuates the big bag (18) during filling of the big bag (18). In order to be able to realize this, the movement element (16) can be a hydraulic piston. Thanks to this actuation, the hazelnut which exists in the big bag (18) is moved and is placed into the big bag (18) with minimum gaps. There is at least one first carrier (17) essentially in the vicinity of the body (14) on the first filling unit (10). Said first carrier (17) is enabling carrying and parking of the big bags (18). For providing this, in a possible embodiment, the first carrier (17) can be a roll conveyor. Thanks to this, the big bags (18) filled by means of the first carrier (17) can be arranged in a predetermined arrangement. There is also at least one pellet feeder (19) on the first filling unit (10). Said pellet feeder (19) essentially provides placement of pellet under the big bag (18) placed on the body (14) for filling. Thanks to this, the big bags (18) can be easily carried by carrying vehicles like forklift.

In the second filling unit (20), the decorticated hazelnut is enabled to be packaged in packages with smaller dimensions when compared with big bag (18). For providing this, the second filling unit (20) is also connected to the guide (40) by means of the second transmission pipe (42). The hazelnut taken from the second transmission pipe (42) is transferred to at least one second cyclone (21). The operation principle of said second cyclone (21) is essentially similar to the first cyclone (11). There is at least one vacuum silo (22) at the continuation of the second cyclone (21). Said vacuum silo (22) is in the form of a chamber which can provide waiting of the hazelnut therein depending on the capacity of the second filling unit (20). At the continuation of the vacuum silo (22), there is at least one collecting band (23). Said collecting band (23) can take the hazelnut, which shall be packaged, at a predetermined amount and can transfer it to at least one lift (24). In the lift (24), at least partial rise can be realized for enabling packaging of the hazelnut. The lift (24) and the collecting band (23) are used in carrying the hazelnut. There is at least one buffer silo (25) at the continuation of the lift (24) in the second filling unit (20). Said buffer silo (25) enables feeding of hazelnut to the second magnetic detector (26) at least partially slowly and one by one. Said second magnetic detector (26) essentially operates in a similar manner with the first magnetic detector (12) provided on the first filling unit (10) and enables separation of the metallic elements. Afterwards, the hazelnut is loaded to at least one filling silo (27) and is made ready for packaging of the hazelnut. There is moreover at least one dosing section (28) at the second filling unit (20). At said dosing section (28), the hazelnut is put at a predetermined amount into the package. For providing this, there is at least one second load cell (31) at the second filling unit (20). Said second load cell (31) has operation principle which is similar to the operation principle of the first load cell (15). Additionally, there is at least one vibration table (29) in the second filling unit (20). Said vibration table (29) provides at least partially vibrating of the package and provides filling thereof with minimum gaps. Additionally, there is at least one vacuum element (30) which can enable suctioning of air which exists in the package during packaging of hazelnut in the second filling unit (20). Said vacuum element (30) provides suctioning of air which exists in the package and facilitates protection of the freshness of the hazelnut. Afterwards, the hazelnut is packaged and is carried to a different station by means of a second carrier (32).

By means of all these embodiments, the hazelnut processed in the hazelnut processing facility is packaged. There is an optional structure for this packaging process. Accordingly, the hazelnut is placed into the big bag (18) or turned into vacuumed packages and the processing is completed depending on the need of the user. This embodiment provides contribution to easily elimination of the packaging problems of hazelnut processing facility.

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

1. A filling method for use in packaging of hazelnut processed in hazelnut processing facilities, wherein the filling method comprises:
at least one first filling unit which provides filling of hazelnut into at least one big bag;
at least one second filling unit which provides vacuuming and putting of hazelnut into packages which are dimensioned in a smaller manner when compared with the big bag; and
at least one guide associated with a hazelnut source that enables selective feeding of hazelnut into at least one of the first filling unit and the second filling unit.

2. The filling method according to claim 1, wherein at least one first magnetic detector and at least one second magnetic detector are respectively provided on the first filling unit and the second filling unit.

3. The filling method according to claim 1, wherein at least one sampling unit is provided on the first filling unit.

4. The filling method according to claim 1, wherein on the first filling unit; at least one body is provided whereon the big bag is positioned and at least one first load cell is provided between the body and the big bag.

5. The filling method according to claim 1, wherein at least one first carrier is provided on the first filling unit.

6. The filling method according to claim 1, wherein at least one pellet feeder is provided on the first filling unit.

7. The filling method according to claim 1, wherein at least one movement element is provided on the first filling unit.

8. The filling method according to claim 1, wherein at least one collecting band and at least one lift are provided for use in carrying the hazelnut on the second filling unit.

9. The filling method according to claim 1, wherein at least one filling silo is provided on the second filling unit.

10. The filling method according to claim 1, wherein at least one second load cell is provided on the second filling unit.

11. The filling method according to claim 1, wherein at least one dosing section is provided on the second filling unit.

12. The filling method according to claim 1, wherein at least one vacuum element is provided on the second filling unit.

13. The filling method according to claim 1, wherein a vibration table is provided on the second filling unit.

14. The filling method according to claim 1, wherein at least one second carrier is provided on the second filling unit.
